(19) United States
(12) Patent Application Publication
(10) Pub. No.: US 2020/0350108 A1
(43) Pub. Date: Nov. 5, 2020

(54) MULTI-CORE COMMON-MODE CURRENT SUPPRESSION DEVICE

(71) Applicant: PDS Electronics, Inc., Tallmadge, OH (US)

(72) Inventor: Paul D. Sergi, Peninsula, OH (US)

(73) Assignee: PDS Electronics, Inc., Tallmadge, OH (US)

(21) Appl. No.: 16/863,088

(22) Filed: Apr. 30, 2020

Related U.S. Application Data
(60) Provisional application No. 62/841,081, filed on Apr. 30, 2019.

(51) Int. Cl. H01F 17/06; H01F 27/28; H01F 1/34; H01F 1/147

(52) U.S. Cl. CPC H01F 17/06; H01F 27/2823; H01F 2017/0093; H01F 1/14766; H01F 1/34

(57) ABSTRACT

A multi-core common-mode current suppression device (CMD), such as a balun and line isolator, includes at a pair of spaced cores. The cores may be separated by a spacer, such that in the case of a pair of toroidal cores, the axial centers of the cores may be arranged parallel to each other or coaxial with each other. Such a configuration allows the multi-core (CMD) to achieve higher levels of overall common-mode impedance (CMI) as compared to that of existing CMDs that utilize a stacked core configuration.

### CROSS-REFERENCE TO RELATED APPLICATION

This application claims the benefit of U.S. Provisional Patent Application No. 62/841,081 filed on Apr. 30, 2019, the contents of which are incorporated herein by reference.

### TECHNICAL FIELD

The various embodiments disclosed herein relate to common-mode current suppression devices. In particular, the various embodiments disclosed herein relate to common-mode current suppression devices that utilize multiple cores. More particularly, the various embodiments disclosed herein relate to common-mode current suppression devices, such as baluns and line-isolators that utilize multiple spaced toroidal cores.

### BACKGROUND

Providing common-mode current suppression devices, hereinafter referred to as CMDs, such as baluns and line isolators, which have increased levels of common-mode impedance (CMI) is highly advantageous. Such devices are highly sought after by consumers, such as those who participate in the field of HAM (i.e. amateur) radio, as well as military and commercial industries. Currently, manufacturers increase the CMI of their CMD devices by utilizing a core with increased magnetic permeability; or by stacking multiple cores together to form a “stacked core”, whereupon multiple turns of coaxial cable, or parallel wires are wound through the entire stack. However, while the stacked-core arrangement does increase the CMI over that of a single core, the amount by which CMI is increased is not proportional to the number of cores used in the stack. In fact, there is always a percentage or portion of impedance that the stacked core is unable to attain.

Therefore, it would be desirable to provide a multi-core common-mode current suppression device (CMD) in which the total common-mode impedance (CMI) achieved is more closely proportional to the number of cores used, so as to allow a multi-core CMD to achieve higher levels of overall CMI as compared to that of current generation CMDs, which use the same number of cores but in a stacked configuration.

### SUMMARY

It is a first aspect of the various embodiments disclosed herein to provide a current suppression device that includes a first core having an aperture; a second core having an aperture, with the second core being spaced apart from the first core; a spacer positioned between the first core and the second core; and a conductive wire forming at least one at least partial winding through the aperture of the first core, and the conductive wire forming at least one at least partial winding through the aperture of the second core.

It is another aspect of the various embodiments disclosed herein to provide a current suppression device that includes a plurality of cores each having an aperture therethrough; a plurality of spacers, wherein each consecutive group of cores is separated by at least one spacer; and a conductive wire forming at least one at least partial winding through the aperture of each the core.

### BRIEF DESCRIPTION OF THE DRAWINGS

The various embodiments disclosed herein will become better understood with regard to the following description, accompanying drawings and claims wherein:

FIG. 1A is a perspective view of a side of one embodiment of a multi-core common-mode current suppression device (CMD) having multiple horizontally spaced cores in accordance with the concepts of the various embodiments disclosed herein;

FIG. 1B is a perspective view of another side of the multi-core CMD shown in FIG. 1A in accordance with the concepts of the various embodiments disclosed herein;

FIG. 2 is an exploded view of another embodiment of a CMD having multiple vertically spaced cores in accordance with the concepts of the various embodiments disclosed herein;

FIG. 3 is a perspective view of an assembled multi-core CMD shown in FIG. 2 in accordance with the concepts of the various embodiments disclosed herein;

FIG. 4 is a perspective view of a plurality of multi-core CMDs, as shown in FIG. 1, which are linked together in accordance with the concepts of the various embodiments disclosed herein;

FIG. 5 is a perspective view of a plurality of multi-core CMDs, as shown in FIG. 3, which are linked together in accordance with the concepts of the various embodiments disclosed herein;

FIG. 6 is a graph showing common-mode impedance (CMI) vs. frequency performance between the CMD operating as a balun having horizontally spaced cores and conventional stacked baluns D9T and D11T in accordance with the concepts of the various embodiments disclosed herein;

FIG. 7 is a graph showing common-mode impedance (CMI) vs. frequency performance between the CMD operating as a balun having horizontally spaced cores and a CMD operating as a balun having vertically spaced cores in accordance with the concepts of the various embodiments disclosed herein;

FIG. 8 is a graph showing the impedance of a single toroidal core and a dual toroidal core formed of Mix 31 brand material;

FIG. 9 is a graph showing the impedance of a single 1″ bead core and a Siamese 1″ bead core formed of Mix 31 brand material;

FIG. 10 is a graph showing the impedance of a single core and a pair of spaced and vertically oriented cores formed of Mix 31 brand material in accordance with the concepts of the various embodiments disclosed herein;

FIG. 11 is a graph showing the impedance of a single core, a dual core and a pair of single spaced vertically oriented cores in accordance with the concepts of the various embodiments disclosed herein;

FIG. 12 is a graph showing the impedance of a single core, a Siamese core and two bead cores formed of Mix 31 material in series;

FIG. 13 is a graph showing the impedance of a single core, dual core and two separated toroid cores formed of Mix 31 material; and

FIG. 14 is a graph showing the impedance of a single core, Siamese core and two bead cores in series.

### DETAILED DESCRIPTION

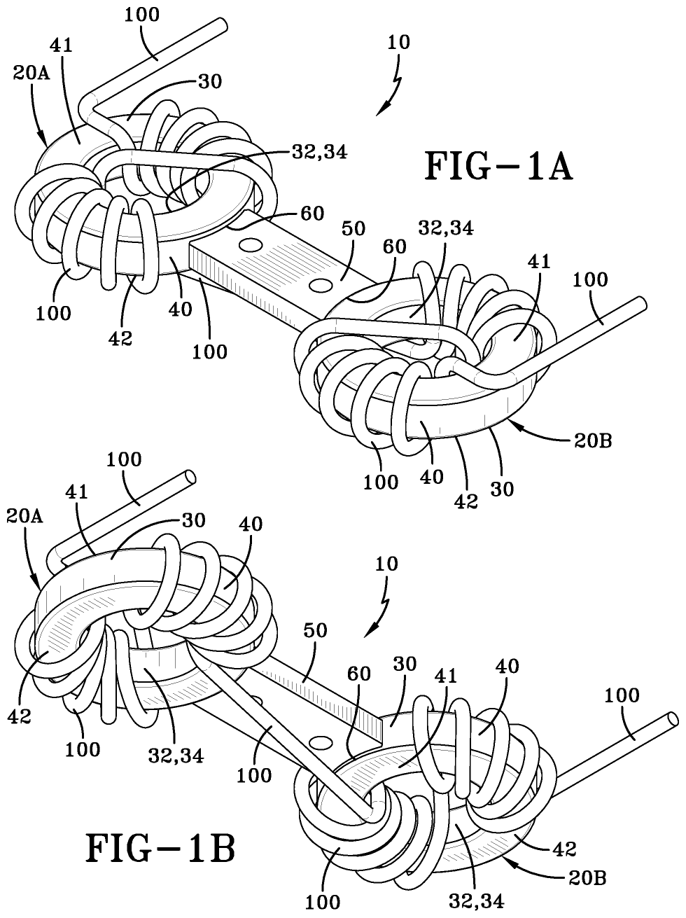

A multi-core common-mode current suppression device 10, referred to herein as a CMD, is shown in FIGS. 1A-B. It should be appreciated that the CMD 10, may be configured to operate as a balun or line isolator depending on its manner of attachment to electrical equipment for which it is being used. The CMD 10 is configured to be placed into electrical communication with an electrically conductive wire, such as a coaxial cable, to convert balanced RF (radio frequency) signals into unbalanced RF signals, and vice versa. That is, the CMD 10 may be configured to convert a balanced RF signal input that is provided by the electrical communication line to an unbalanced RF signal output, and therefore operate as a BALUN. Alternatively, the CMD 10 may be configured to operate as a line isolator or UNUN, so as to convert an unbalanced RF input signal provided by the electrical communication line to an unbalanced RF output signal.

In the embodiment shown in FIGS. 1A-B, the CMD 10 includes a pair of toroid cores 20A and 20B. Each of the cores 20A-B may be formed of any suitable ferrite material, or composites thereof. In some embodiments, the cores 20A-B may be formed by a ferrite material having a composition of manganese and zinc (MnZn ferrite), which is offered under the tradename “31 Material” that is sold by Fair-Rite Products Corp. The cores 20A-B may be formed of nanocrystalline material. In some embodiments, the nanocrystalline material may have the chemical compound FeCuNbSiB, where Fe is iron; Cu is copper; Nb is niobium; Si is silicon; and B is boron. It should be appreciated that in some embodiments, the nanocrystalline material may comprise the chemical compound Fe_{73.5}Cu₁Nb₃Si_{15.5}B₇, and the like. It should be appreciated that the nanocrystalline material may comprise a composite material that includes one or more other materials. It should be appreciated that while cores 20A and 20B are discussed herein as being toroidal cores, cores 20A and 20B may take on any shape or design, such as Siamese cores for example.

The toroid cores 20A-B each has a body 30 that is bounded by a cylindrical inner surface 32, a cylindrical outer peripheral surface 40, and a pair of opposed lateral annular surfaces 41,42. The inner surface 32 defines an aperture 34 that extends through the toroid body 30. The diameter of the outer peripheral surface 40 of the cores 20A-B may be any suitable dimension, such as about 2.4″ for example, but is not required.

The cores 20A-B are spaced apart from each other by a space or gap formed by a spacer 50. The spacer 50 may be formed of any suitable dielectric, or electrically non-conductive material, such as plastic or polyester for example. In some embodiments, the spacer 50 may comprise a planar or flat section of material, but may have any suitable shape, size or dimension desired. In addition, the spacer 50 may have concave surfaces 60 at each terminal end thereof to accommodate the curved outer peripheral surface 40 of the toroidal cores 20A-B. As such, the toroid cores 20A-B are positioned in the same plane, so that the axes extending through the axial centers of the apertures 34 are substantially parallel to each other. However, in other embodiments, the cores 20A-B may be oriented at any desired position or angle. Thus, the CMD 10 is configured to have a substantially flat or planar configuration and may be referred to as having horizontally spaced cores 20A-B, however the CMD 10 and cores 20A-B may be positioned in any orientation. Furthermore, the spacer 50 is configured to have a suitable length dimension to space the cores 20A-B apart to prevent them from electrically/magnetically interacting with each other. In some embodiments, the spacer 50 may be attached to each of the cores 20A-B by use of a fastener, such as a rivet, or adhesive for example.

Continuing, a single section or length of coaxial cable 100 is wound around each of the toroid cores 20A-B. In particular, the coaxial cable 100 includes a central conductor that is separated from a conductive outer cladding by an inner dielectric material, while the conductive outer cladding is covered by an outer dielectric material to shield it from the external environment. It should be appreciated that in some embodiments the coaxial cable 100 may comprise cables having the standard industry designation of RG303, RG400 or RG142 (where RG refers to “Radio Guide”) for example. The coaxial cable 100 is wound around the inner and outer surfaces 32,40 of the core 20A, then extends across the gap formed by the spacer 50 before being wound around the inner and outer surfaces 32,40 of the core 20B. It should be appreciated that the coaxial cable 100 forms at least one partial wrap/turn/winding that is positioned about, around or relative to the body 30 of the core 20A that also passes through the aperture 34 of the core 20A, and that forms at least one partial wrap/turn/winding that is positioned about, around or relative to the body 30 of the core 20B that also passes through the aperture 34 of the core 20B. It should be appreciated that in some embodiments, the coaxial cable 100 may be wound around each of the cores 20A-B with the same number of turns (1:1 or symmetrical number of coaxial cable turns). Alternatively, the coaxial cable 100 may be wound around the cores 20A-B so that one core has more turns than the other core (asymmetric number of coaxial cable turns). Once wound around the cores 20A-B, the terminal ends of the coaxial cable 100 are attached to the desired electrical equipment, and the CMD 10 is placed into operation.

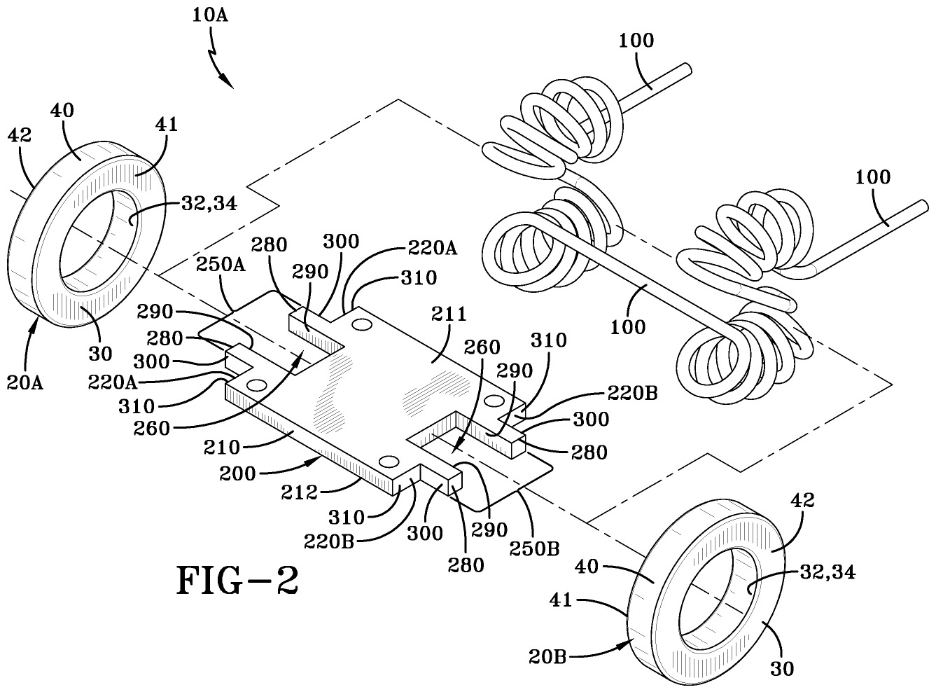

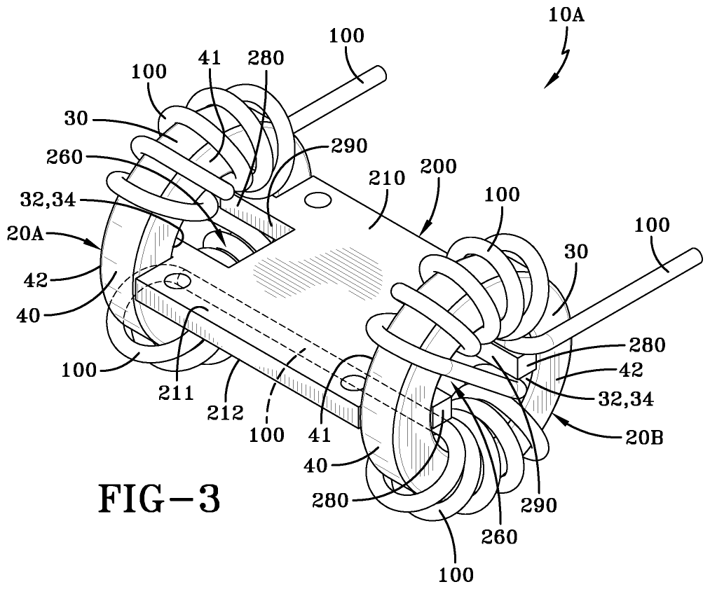

In another embodiment, a CMD 10A is shown in FIGS. 2-3. The CMD 10A utilizes the toroid cores 20A-B and coaxial cable 100 as previously discussed but arranges the cores 20A-B so that the axial centers of each of apertures 34 of the cores 20A-B are coaxially aligned with each other. The coaxial arrangement of the cores 20A-B is maintained by a spacer 200, as shown clearly in FIG. 2. Furthermore, the spacer 200 is configured to have a suitable length dimension to space the cores 20A-B apart to prevent them from electrically/magnetically interacting with each other.

Continuing, the spacer 200 is formed of a section of any suitable dielectric, or electrically non-conductive material, such as plastic or polyester for example. The spacer 200 includes a body 210 having opposed surfaces 211 and 212, which include substantially opposed lateral edges 220A and 220B. Extending from each lateral edge 220A,220B are respective sets 250A and 250B of projections 280. The projections 280 of a given set 250A-B are separated by a gap 260. The projections 280 of each set 250A-B have an inner surface 290 and substantially opposed outer surface 300. Each set of projections 250A-B is configured so that it is received within the aperture 34 of a respective core 20A-B. In some embodiments, the projections 280 are configured to touch or be friction fit with or against the inner surface 32 of the aperture 34 of the cores 20A-B. In some embodiments, the spacer 200 includes one or more support surfaces 310, whereby each support surface 310 is positioned at a substantially right angle to the particular projection 280 to which the support surface 310 is associated. Thus, when the projections 280 are received within the apertures 34 of a particular core 20A-B, the support surfaces 310 of the spacer 200 are placed adjacent to the lateral surface 41 of that given core 20. In addition, the gap 260 disposed between adjacent projections 280, facilitates the winding of the cable 100 around the cores 20A-B. Thus, the CMD 10A may be referred to as having vertically spaced cores 20A-B, whereby the axial centers of the apertures 34 of cores 20A-B are coaxial with each other. However, in other embodiments, the cores 20A-B may be oriented at any desired position or angle. In some embodiments, the projections 280 may be configured to be friction fit within the apertures 34 of the cores 20A-B. Furthermore, the cores 20A-B may be attached to the spacer 200 via a fastener, such as rivets, or adhesive for example.

It should be appreciated that the multi-core CMDs 10 and 10A are configured so that the cores 20A and 20B are physically coupled or linked in series by the coaxial cable 100, as well as being electrically and/or magnetically coupled together by the coaxial cable 100. Furthermore, the arrangement of the coaxial cable 100 relative to the cores 20A and 20B in this embodiment of the CMD 10A is equivalent to that previously discussed above in FIG. 1 with regard to CMD 10.

Furthermore, the CMDs 10 and 10A and their utilization of series-coupled spaced cores allows the total impedance of its “N” number of cores to achieve an impedance that is substantially closer to “N” times the impedance of a single core. That is, the total CMI achieved by the CMDs 10 and 10A is more closely proportional to the number of cores used. In addition, the series resonant frequency (SRF) of the CMDs 10 and 10A is increased over conventional CMDs having stacked cores. Moreover, the width of the increased impedance provided by CMDs 10 and 10A is wider than that of conventional CMDs having stacked cores.

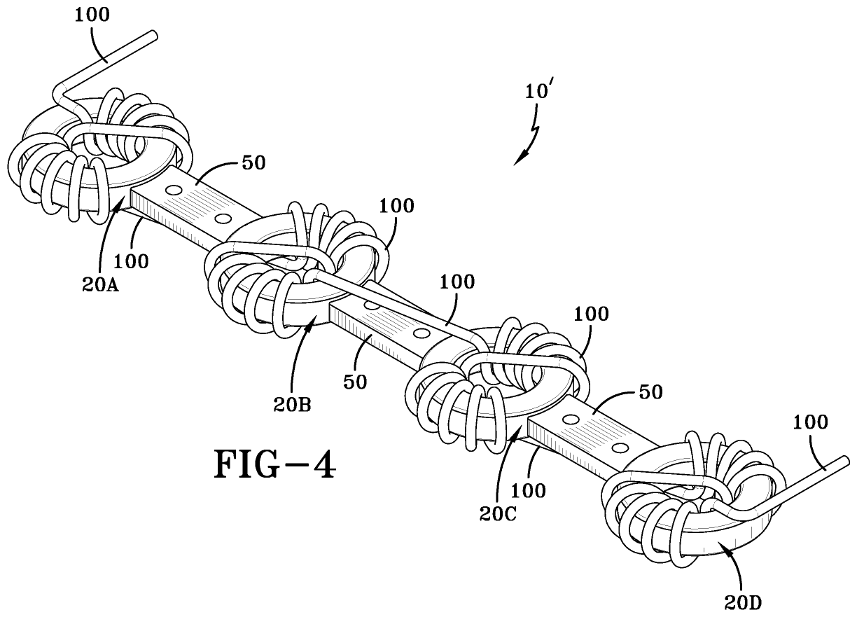

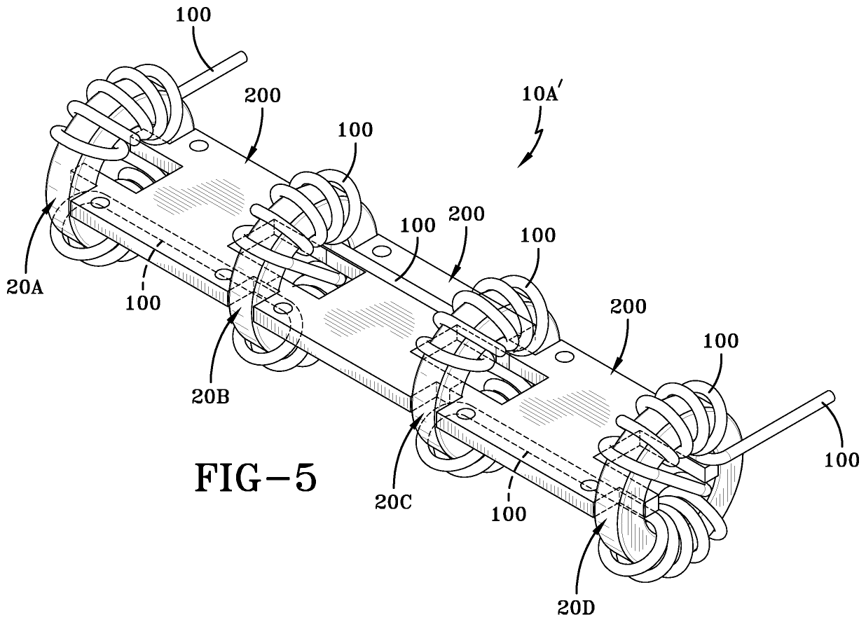

It should also be appreciated that CMD 10 and 10A may be configured, whereby more than 2 cores and a single spacer are used to form the CMD. For example, an alternative embodiment of CMD 10, referred to as 10′, is shown in FIG. 4, which includes 4 cores 20A-D and 3 spacers 50. In another example, an alternative embodiment of CMD 10A, referred to as 10A′, is shown in FIG. 5, which includes 4 cores 20A-D and 3 spacers 200. Thus, the alternative embodiments 10′ and 10A′ may be configured to be in series with each other through the coupling of the coaxial cable 100. In some embodiments, the cores 20 and spacers 50/100 may be provided in a linear configuration, as shown in the FIGS. 4 and 5. However, it should be appreciated that the cores 20 and spacers 50/100 of CMD 10′ and 10A′ may be arranged at any angle or position to one another so as to form configurations that are not linear.

It should be appreciated that in other embodiments of the CMD 10 and 10A, the coaxial cable discussed herein may be replaced with any suitable electrically-conductive wire having one or more conductors, whereby one or more of those conductors may be insulated by a dielectric material. In addition, while the cores disclosed herein are referred to as being toroidal, it is contemplated that other core shapes may be utilized by the various embodiments disclosed herein, such as a rectangular shape, a curvilinear shape or a shape that is a combination of both, so long as the core has an aperture disposed therethrough to permit at least a partial winding of the conductive wire to be placed therethrough. It is also contemplated that the cores 20A-B may each comprise multiple cores, including stacked cores.

### Experimental Section I

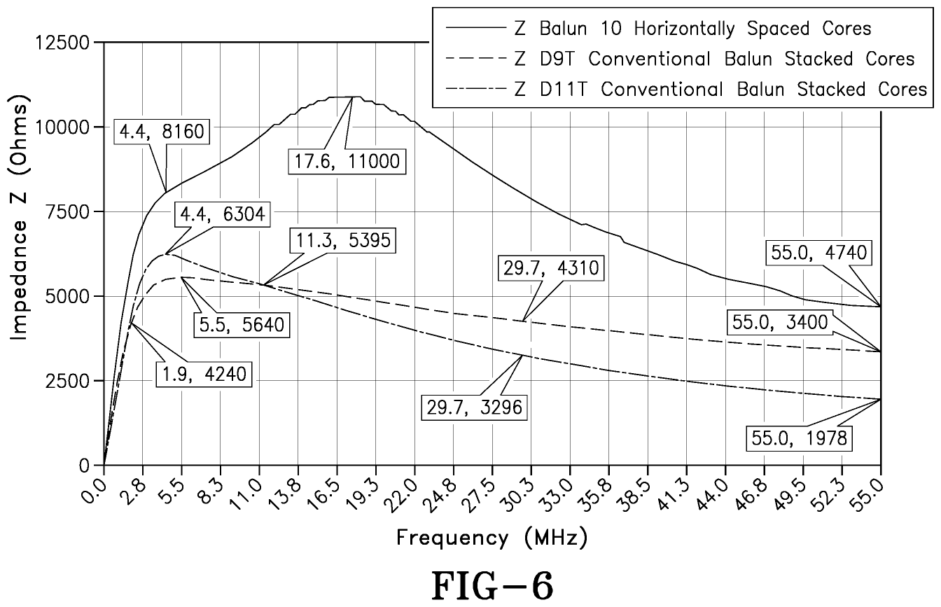

FIG. 6 compares the common-mode impedance (CMI) performance of CMD 10 configured as a balun with two prior art 1:1 baluns/ununs that each include two toroidal stacked cores, which are coaxially aligned, and taped together, then wrapped with 50 Ohm coaxial cable having a PTFE dielectric. The cores of balun 10, and the conventional “stacked core” baluns, which are denoted as D9T and D11T in FIG. 4, are formed of the “31 Material”. The coaxial cable may be RG (i.e. radio guide) 303, 400 or 142 for example, although other coaxial cable types may be utilized. All of the coaxial cables used were nominally the same size using either stranded or solid center conductors, and either single or double braid shielding. The RG303 coaxial cable has a solid center conductor and a single braid shield, thereby having a smaller turn radius, in other words, the coaxial cable is able to be positioned closer to the core(s) of the baluns being tested. Thus, in the case of balun D11T, which is wrapped with 11 turns of coaxial cable using a Reisert method, the choking impedance peaks around 4.4 MHz and falls off rather quickly. If the turns of the coaxial cable are reduced to 9 turns, such as in the case of balun D9T, the peak impedance is lowered, but the impedance is reduced less over a desired frequency range. In addition, when the balun 10 is utilized with its horizontally spaced cores 20A-B being wound with 11 turns of the coaxial cable, and the sum of the impedance is greater than the baluns D9T and D11T that utilize dual stack cores. Furthermore, while the rate of impedance reduction of balun 10 is greater than the stacked core configurations of baluns D9T and D11T, the amount of impedance that is achieved by balun 10 is greater than conventional baluns D9T and D11T, which is highly desirable.

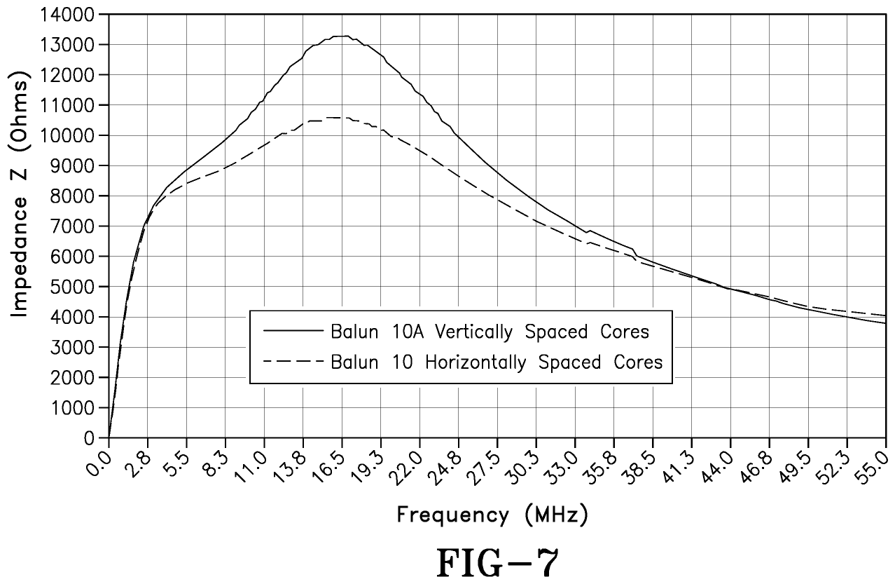

FIG. 7 shows the common-mode impedance (CMI) performance between CMD 10 and CMD 10A operating as baluns, which each include cores 20A-B formed of the “31 Material” and that are wrapped with 11 turns of coaxial cable 100. As such, FIG. 7 demonstrates that the vertically oriented cores of balun 10A achieves a better performance level than that of the horizontally oriented cores of balun 10 over most of the frequency range.

### Experimental Section II

A part of what contributes to a better performing common-mode current suppression device is one that offers higher common mode impedance (CMI) over a wider frequency range.

Common mode impedance with respect to a coaxial cable refers to the impedance to the flow of electrical current on the outside surface of the coaxial cable. This current usually manifests itself in the form of radio frequency interference (RFI) which is defined as a disturbance that is generated by an external source that affects an electrical circuit and degrades the performance of the circuit or even stops it from functioning. With regard to its application to communication systems, RFI degrades or destroys the integrity of RF signals transmitted over an electrically conductive wire.

Baluns and line isolators reduce RFI in proportion to their CMI. Thus, more CMI gives reduced common-mode current and less RFI. The nearly universal method for constructing a balun or line isolator that exhibits relatively good CMI is to use a 2.40″ OD×1.40″ ID×0.500″ thick ferrite toroid core and to wind coaxial cable through it.

More wire turns generate more CMI, but it generally reduces the frequency band over which the CMI is increased. Conversely, fewer wire turns result in lower CMI spread over a wider bandwidth.

In the event that the CMI is deemed insufficient, a generally accepted method to increase it is to either use a core with increased permeability (inductance/turn) in the frequency range of interest, or if this is not available, then to stack 2 or more cores and route the coaxial cable through multiple cores. However, as a result of the reduction in CMI bandwidth that occurs with stacking, using more than a double stack is rare when making baluns and line isolators. Hence, many baluns and line isolators are built with a double stack.

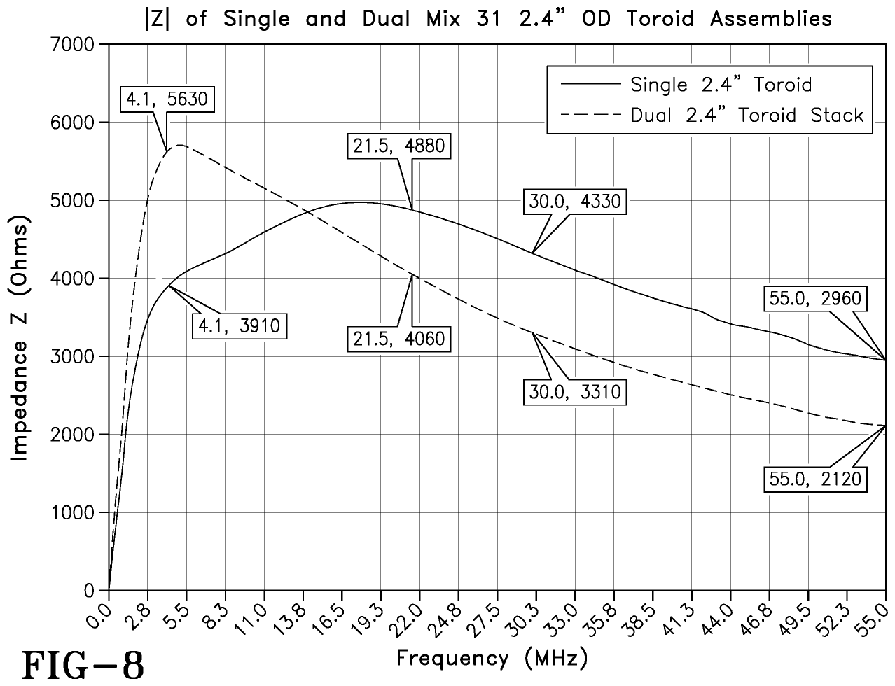

FIG. 8 illustrates that stacking cores in a dual or double core design using a core formed of Mix 31 brand material (a Manganese-Zinc material) has benefits, as well as disadvantages. The CMI for a double stack core is increased at the lower frequencies, but is reduced at higher frequencies as compared to the single core. Also apparent from FIG. 8 is the reduction in CMI bandwidth that occurs using this configuration.

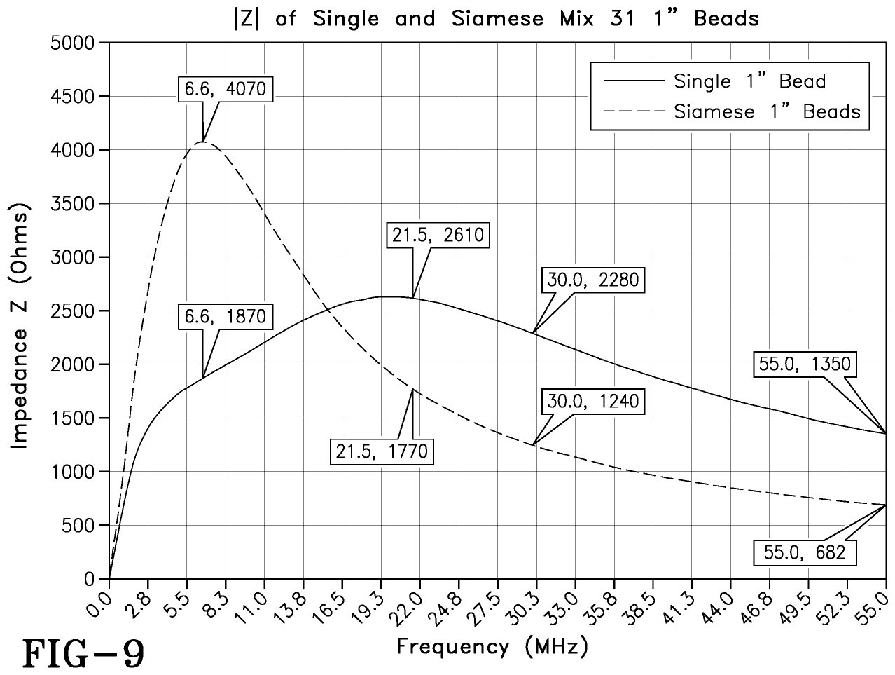

Alternatively, line isolators have been built using smaller cores. In this case, the method typically chosen to increase CMI is placing these smaller cores side by side in a “Siamese” configuration and then running the coaxial cable or wire through both of the cores. This method of combining multiple cores has similar performance tradeoffs, as shown in FIG. 9, to the configuration discussed with regard to the prior example in FIG. 8, whereby a large increase in CMI occurs at the lower frequencies and a large decrease in CMI at the higher frequencies.

Thus, while such method provides desirable performance at lower frequencies, there is a need for a device that has a high CMI over a wider CMI bandwidth.

The CMI tradeoff in both examples, shown in FIGS. 6 and 7, where the cores are doubled up is due to the increase in the inductance associated with the increased length of coaxial cable or wire, as well as the increase in the inter-turn capacitance also brought about by the increased coaxial cable length, as well as the necessary overlap of the wires in this configuration.

It is generally known that the inductance of an electrically conductive wire or cable in a coil form is linearly proportional to its length. Also, the inter-turn capacitance is also linearly proportional to the length of the wire used in the assembly. Furthermore, the length of the wire circumscribing the cross-section of the double stacked assembly is 50% longer than the wire used on the single stack Siamese configuration for the same number of turns. As shown in the previously discussed examples, an increase in the amount of inductance and capacitance in this type of device decreases the frequency of maximum impedance, increases the maximum impedance, and decreases the bandwidth of the increased impedance.

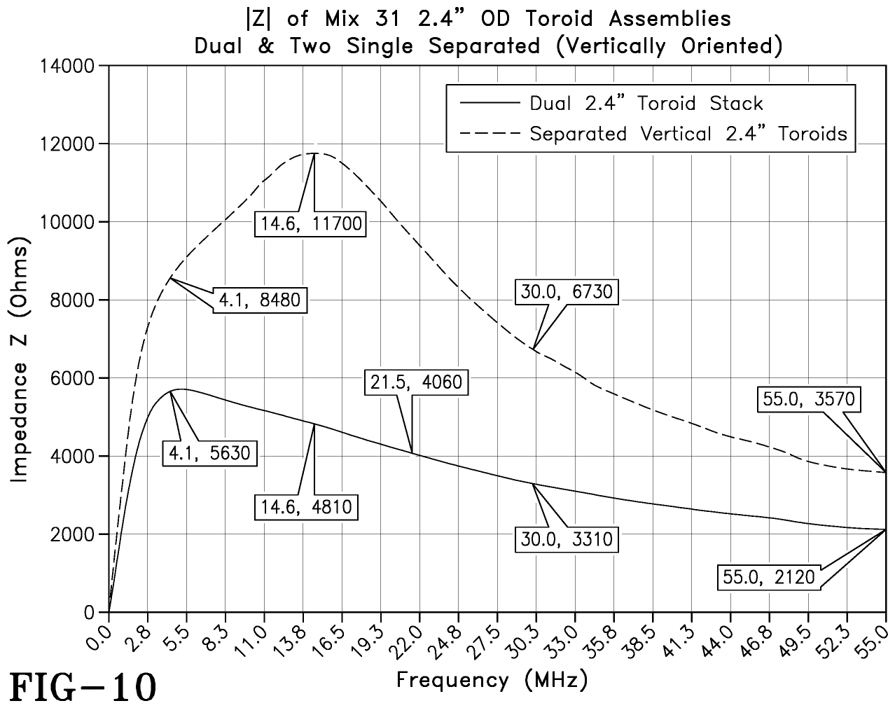

As shown in FIG. 10, the cores were formed of Mix 31 brand material (manganese-zinc) having a 2.4″ OD, whereby the separated cores produce a substantial increase in CMI as compared to a stack of 2 cores and the increase is over the whole frequency range of interest.

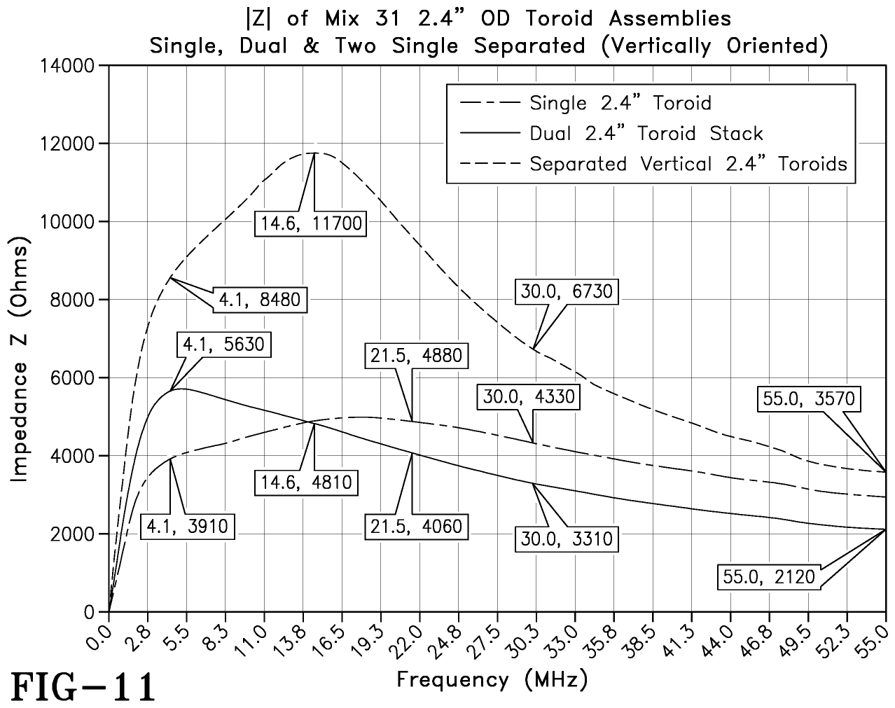

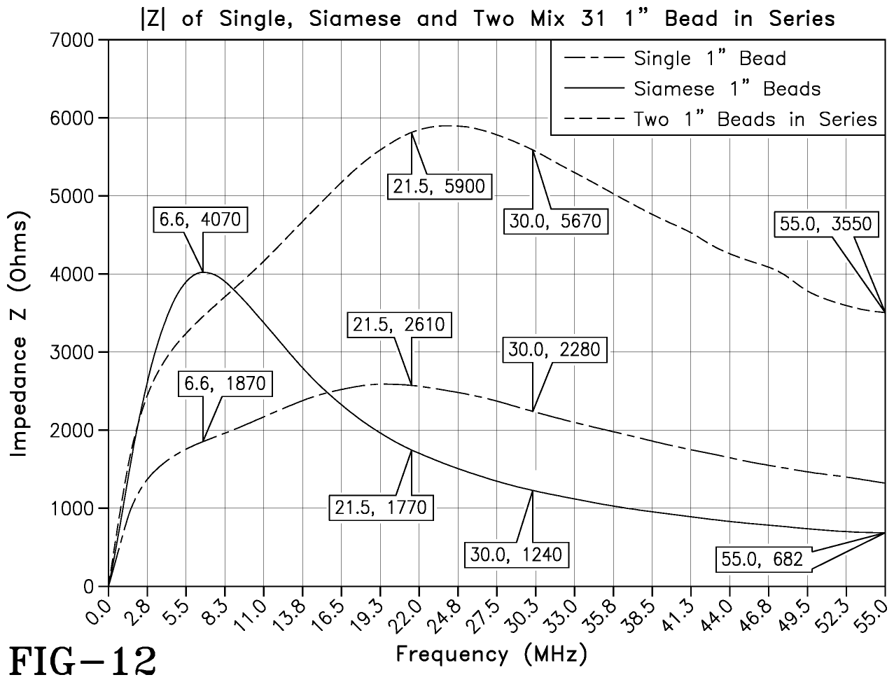

As an alternative to stacking or placing the cores into a Siamese configuration, single cores were evaluated of any size, with many wire wraps/turns being made therethrough. In particular, two or more of those single-core assemblies were put in series with each other. The CMI associated with each arrangement of both the 2.4″ OD and the 1″ OD cores was measured, as shown in FIGS. 11 and 12.

Three items of interest were noticed when transitioning from the use of a double-stack core to using single cores that are spaced apart so as to reduce any interaction (as shown in the embodiments in FIGS. 1-3): 1.) The peak Impedance, Zₚ, of the spaced single core assembly was greatly increased; 2.) The frequency at which the peak impedance occurred for the spaced single core was greatly increased, and 3.) The bandwidth of the peak impedance was also greatly increased. This resulted in much more area-under-the-curve.

For the sake of completeness, FIG. 11 shows the comparison between all of the arrangements of the Mix 31 brand manganese-zinc material, whereby the 2.4″ OD cores are configured as: a single core; a dual stacked core; and as two single vertically separated cores 10A.

Next, the 1″ core formed from the Mix 31 brand material (manganese-zinc material) was tested in the following arrangements: a single core, a Siamese core; and two beads in series. Again, as shown in FIG. 12, the two separated cores arranged in series produce a substantial increase in CMI over most of the frequency range of interest as compared to a Siamese arrangement of 2 cores. There is a small area from about 2.7 MHz to a little over 8.4 MHz where the Siamese arrangement shows about 500 Ohms more CMI, but the CMI in that area is still more than adequate for most applications, and it is acceptable in order to achieve up to a 4700 Ohm increase in other areas. Actually, if it is important that the CMI be larger at the lower frequencies an additional 1-2 turns on the beads will provide that increase, but will cause a small reduction of CMI at higher frequencies.

The frequency range of interest for the greatest number of users of the device is 0.5 MHz and above. This allows the device to have an effect on the AM (amplitude modulation) broadcast band—where transmitter powers can be in the 50 KW range—up to about 55 MHz where the amateur radio 6 meter band is located. Others are interested in increased CMI on higher frequency ranges and this method would work there also, but a different mix of ferrite would be necessary.

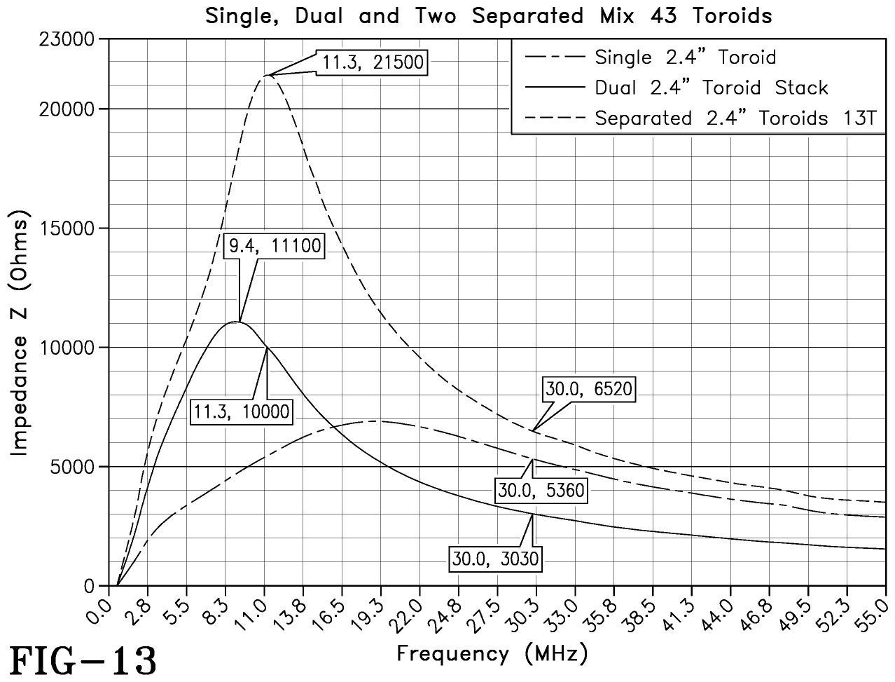

As can be seen from the graphs, the devices of 10 and 10A discussed herein will increase the CMI of a device that is made with ferrite (or other magnetic material), as well as nanocrystalline material over the frequency range of interest and more. Another popular ferromagnetic material is Mix 43 brand nickel-zinc material. FIG. 13 shows that Mix 43 brand material achieves a performance that is similar to that of the Mix 31 brand material. First, for the 2.4″ OD toroid, merely stacking the cores, gives a higher CMI, the narrow peak of which occurs lower in frequency. In addition, the bandwidth of the CMI curve is also narrower than the single core. FIG. 13 also shows that using 2 separated cores results in a higher CMI and a wider peak CMI resulting in much more area-under-the-curve. While the core formed Mix 43 brand material does not have as much area under the curve as the separated core formed of Mix 31 materials, it is still very useful.

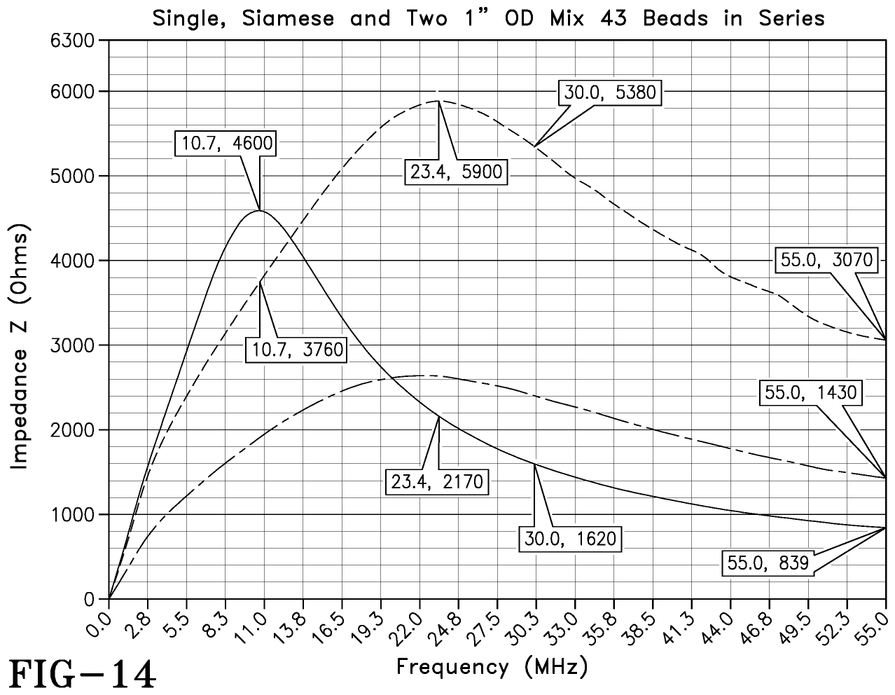

Next, 1″ cores formed of Mix 43 brand material (nickel-zinc material) in the following arrangements where evaluated: a single core; a Siamese cores, and two beads in series. As such, the results shown in FIG. 14 are similar to those of the Mix 31 beads.

Thus, using the separated core/bead configuration of the embodiments 10 and 10A provides a much higher CMI peak, as well as a wider bandwidth than the stacked or Siamese core arrangements. In addition, the CMI peak of embodiments 10 and 10A occurs between that which is exhibited by the stacked and the single core.

Therefore, it can be seen that the objects of the various embodiments disclosed herein have been satisfied by the structure and its method for use presented above. While in accordance with the Patent Statutes, only the best mode and preferred embodiments have been presented and described in detail, with it being understood that the embodiments disclosed herein are not limited thereto or thereby. Accordingly, for an appreciation of the true scope and breadth of the embodiments, reference should be made to the following claims.

What is claimed is:

1. A current suppression device comprising:
a first core having an aperture;
a second core having an aperture, said second core spaced apart from said first core;
a spacer positioned between said first core and said second core; and
a conductive wire forming at least one at least partial winding through said aperture of said first core, and said conductive wire forming at least one at least partial winding through said aperture of said second core.

2. The current suppression device of claim 1, wherein said first and second cores are toroid cores.

3. The current suppression device of claim 2, wherein an axial center of said aperture of said first core and an axial center of said aperture of said second core are parallel to each other.

4. The current suppression device of claim 2, wherein an axial center of said first aperture of said first core and said second aperture of said second core are coaxial with each other.

5. The current suppression device of claim 1, wherein said conductive wire comprises a coaxial cable.

6. The current suppression device of claim 1, wherein said first core and said second core are formed of a ferrite material, a ferrite composite material, or MnZn ferrite material.

7. The current suppression device of claim 1, wherein said first core and said second core are formed of nanocrystalline material.

8. The current suppression device of claim 7, wherein said nanocrystalline material comprises FeCuNbSiB.

9. The current suppression device of claim 7, wherein said nanocrystalline material comprises Fe_{73.5}Cu₁Nb₃Si_{15.5}B₇.

10. The current suppression device of claim 1, wherein said at least one partial winding through said aperture of said first core comprises a plurality of windings and said at least one partial winding through said aperture of said second core comprises a plurality of windings.

11. The current suppression device of claim 10, wherein said plurality of windings associated with said first core is a different amount than said plurality of windings associated with said second core.

12. The current suppression device of claim 1, wherein said spacer includes a first set of protrusions and a second set of protrusions, wherein said first set of protrusions are received within said aperture of said first core and said second set of protrusions are received within said aperture of said second core.

13. The current suppression device of claim 12, wherein said first and second set of protrusions are friction fit within said apertures.

14. The current suppression device of claim 1, wherein said spacer is formed of dielectric material.

15. The current suppression device of claim 1, wherein said spacer is attached to each said core.

16. The current suppression device of claim 1, wherein said spacer has a pair of concave ends each of which receives one of said cores.

17. A current suppression device comprising:
a plurality of cores each having an aperture therethrough;
a plurality of spacers, wherein each consecutive group of cores is separated by at least one spacer; and
a conductive wire forming at least one at least partial winding through said aperture of each said core.

18. The current suppression device of claim 17, wherein said plurality of cores comprise toroid cores.

19. The current suppression device of claim 17, wherein an axial center of said aperture of said cores are parallel to each other.

20. The current suppression device of claim 17, wherein an axial center of said aperture of said cores are coaxial with each other.
